(19) United States
(12) Patent Application Publication
(10) Pub. No.: US 2023/0142500 A1
(43) Pub. Date: May 11, 2023

(54) BATTERY MODULES WITH ANTI-ARCING, HOT SWAPPING, AND/OR SELF-DISABLING FEATURES

(71) Applicant: EnerSys Delaware Inc., Reading, PA (US)

(72) Inventors: Alinaghi Marzoughi, Reading, PA (US); Benjamin Meyer, Reading, PA (US); Brian Venus, Reading, PA (US); Mohammed Kechmir, Wyomissing, PA (US); Joern Tinnemeyer, Reading, PA (US)

(21) Appl. No.: 17/523,204

(22) Filed: Nov. 10, 2021

(51) Int. Cl. H02J 7/00

(52) U.S. Cl. CPC H02J 7/007182; H02J 7/0013

(57) ABSTRACT

Battery modules with anti-arcing, hot swapping, and/or self-disabling features are provided, as are systems and methods related thereto. For example, an electrical power system configured to provide backup electrical power to a load may include a battery rack having a bus configured to provide power. The system may include a battery module configured to couple with the bus and receive power therefrom, the battery module may include battery cells coupled to a pre-charge electrical path and a main electrical path, and a module controller configured to: detect that the battery module has been inserted into the battery rack, and pre-charge the battery cells of the battery module via the pre-charge electrical path until a voltage level of the battery cells may be synchronized with a voltage level of the bus.

### TECHNICAL FIELD

The present disclosure relates to battery modules for powering equipment, and in particular relates to battery modules with anti-arcing, hot swapping, and/or self-disabling features.

### BACKGROUND

Batteries have become increasingly important, with a variety of industrial, commercial, and consumer applications. Interest and research in batteries has resulted in a variety of battery chemistries, with differing benefits and drawbacks. For example, “flooded” lead-acid batteries tend to be more economical, but may require periodic maintenance such as replenishment of an electrolyte, which can spill. “Sealed” lead-acid batteries may require periodic maintenance via charging or “overcharging” of the battery to prevent stratification. Alternative lead-acid batteries may use a gelled electrolyte, which cannot spill and avoid acid liberation problems, but have their own drawbacks in that the internal resistance may be higher, limiting the ability of such batteries to deliver high currents.

Lithium-ion batteries are another kind of battery chemistry, which have been consistently gaining market share in an ever-growing list of applications. This growth has been spurred by many advantages that lithium-ion technology offers, such as a lower total cost of ownership, an increased power density, a lighter weight, an increased energy density, and a higher specific energy. One particular area of growth for the deployment of lithium-ion batteries has been in battery backup and energy storage systems for communication sites (e.g., telecommunications base stations) and data centers. Integration of lithium-ion technology presents new challenges, especially as global reliance on power for telecommunications, data centers, and energy storage continues to rise.

### SUMMARY

Some aspects of the present disclosure provide an electrical power system configured to provide backup electrical power to a load. The electrical power system may include a battery rack having a bus configured to provide power. The system may include a battery module configured to couple with the bus and receive power therefrom, the battery module may include battery cells coupled to a pre-charge electrical path and a main electrical path, and a module controller configured to: detect that the battery module has been inserted into the battery rack, and pre-charge the battery cells of the battery module via the pre-charge electrical path until a voltage level of the battery cells may be synchronized with a voltage level of the bus. Methods and devices according to the electrical power system are also provided.

Some aspects of the present disclosure provide an electrical power system configured to provide backup electrical power to a load. The electrical power system may include a battery rack having a bus configured to provide power. The system may include a battery module configured to couple with the bus and receive power therefrom, the battery module may include battery cells coupled to a main electrical path, and a module controller configured to: detect a disconnect action indicating a future removal of the battery module from the battery rack, and open at least one switch along the main electrical path in response to the detection of the disconnect action and prior to the removal of the battery module from the battery rack. Methods and devices according to the electrical power system are also provided.

Some aspects of the present disclosure provide an electrical power system configured to provide backup electrical power to a load. The electrical power system may include a battery rack having a bus configured to provide power. The system may include a battery module configured to couple with the bus and receive power therefrom, the battery module may include battery cells coupled to a main electrical path, and a module controller configured to: detect that the battery module has been removed from the battery rack in a potentially unauthorized manner, and open at least one switch along the main electrical path in response to the detection of the removal of the battery module from the battery rack. Methods and devices according to the electrical power system are also provided.

The present disclosure is not limited to the aspects explicitly recited above, and others will be disclosed or be apparent to those of skill in the art.

### BRIEF DESCRIPTION OF THE DRAWINGS

FIG. 1 is a block diagram of an energy storage/battery backup system.

FIG. 2A is a perspective view of one of the battery modules of FIG. 1.

FIG. 2B is a block diagram of one of the battery modules of FIG. 1.

FIG. 3A is a block diagram of the battery module of FIGS. 2A-B during an initialization and/or pre-charging operation.

FIG. 3B is a block diagram of the battery module of FIGS. 2A-B in a state of operation subsequent to the initialization and/or pre-charging operation of FIG. 3A.

FIG. 4 is a block diagram of the battery module of FIGS. 2A-B illustrating aspects of an unexpected and/or unauthorized removal of the battery module from a battery rack.

FIG. 5 is a schematic diagram of a balancing circuit of the battery cells of FIG. 4.

FIGS. 6-8 are flowcharts illustrating aspects of various methods of controlling and/or operating the system of FIG. 1 and/or the battery module of FIGS. 2A-5.

FIG. 9 is a block diagram of a microcontroller that may be used in the system of FIG. 1 and/or the battery module of FIGS. 2A-5.

Herein, like reference numerals refer to corresponding parts throughout the drawings. Moreover, multiple instances of the same part may be designated by a common prefix separated from an instance number by a dash.

### DETAILED DESCRIPTION

The present disclosure is based on the recognition that the adoption of new storage systems of electrical energy by customers in various applications may in some cases be slowed or halted by marketplace and design considerations. For example, uptime for telecommunications equipment is increasingly important. Service interruptions to install, upgrade, and/or perform maintenance on components of a cellular base station or a network operations center can be highly costly and/or frustrating to affected customers. It is therefore increasingly important that downtime be minimized. Present-day systems do not adequately address this need.

For example, state of the art backup battery systems are typically not hot swappable, and trained personnel and strict policies/procedures are deployed in order to perform commissioning and installation tasks of the battery systems. Such tasks typically consist of preconditioning batteries before connecting them to the electrical distribution system. This preconditioning can take significant time, resulting in high labor costs and/or loss of revenue from downtime.

In more detail, energy storage for telecommunications equipment often includes at least one rack, each having one or more battery modules and a rack controller (which may be integrated into one of the battery modules). It can be a lengthy process to install battery modules in a rack and/or to perform maintenance on the battery modules of the rack. For example, the rack may have a rack voltage, and a battery module to be installed or re-installed may have a different battery module voltage (that may be much lower than the rack voltage). When the battery module is installed or re-installed, an imbalance in voltage between the rack (i.e., the rack voltage) and the battery module (i.e., the battery module voltage) may result in an inrush of current into the battery module, potentially resulting in a dangerous electrical arc or damage to the rack or newly installed battery module.

To address the above and other problems, as well as other technical problems, the present disclosure provides battery modules and electrical power systems that include the battery modules. The battery modules have a design that addresses the need for installation, maintenance, upgrades, and removal of battery modules without service interruption through the inclusion of anti-arcing and/or “hot swappable” features.

Within battery systems, scheduled maintenance periods are only one source of downtime. Unfortunately, another source of downtime stems from the theft of battery modules, in part because the lithium-ion batteries therein have a high value. Battery modules according to the present disclosure, in being easier and/or safer to install and remove from a battery rack, may be actually more susceptible to theft. To address such problems, as well as other technical problems, in some embodiments battery modules according to the present disclosure may include (or may also include) a self-disabling anti-theft feature that results in a battery module being incapable of providing power if removed from the electrical power system in an unauthorized manner.

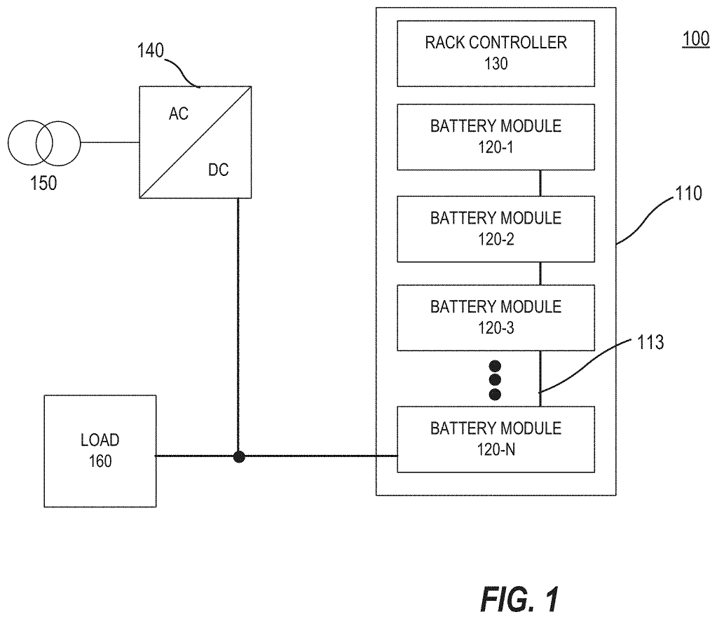

An example embodiment of an electrical power system 100 is provided in FIG. 1. The electrical power system 100 may include a battery rack 110 that may be configured to provide backup electrical power to a load 160, which may be e.g., telecommunications equipment (e.g., a telecommunications station). The electrical power system 100 may be coupled to a grid or main power source 150. In some embodiments, the electrical power system 100 may include a converter (or rectifier) 140 to convert an alternating current (AC) power signal received from the grid or main power source 150 into a direct current (DC) signal that is supplied to the load 160 and to the battery rack 110. In some embodiments, the battery rack 110 may be in series between the grid or main power source 150 and the load 160 and as such may include the rectifier 140 therein.

The battery rack 110 may include one or more (and preferably, two or more) battery modules 120. The battery modules 120 may be connected in series or in parallel to a bus or power line 113 within the battery rack 110. The battery rack 110 may also include at least one rack controller 130 that controls operations of the battery rack 110. For example, the rack controller 130 may include a microprocessor controller that monitors and/or controls system parameters of the battery rack 110 and/or the battery modules 120 thereof, such as voltages (input and/or output voltages), currents (input and/or output currents), temperatures (internal and external to the battery modules 120), and so on. In some embodiments, the rack controller 130 may be connected to an external network (not shown) to provide remote monitoring and/or control of the battery rack 110 to an operator at a remote location from the installation site of the battery rack 110.

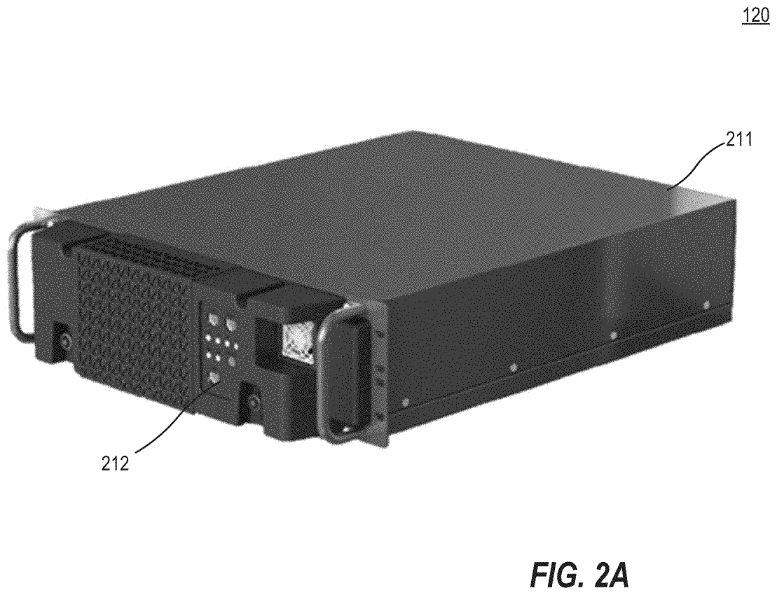

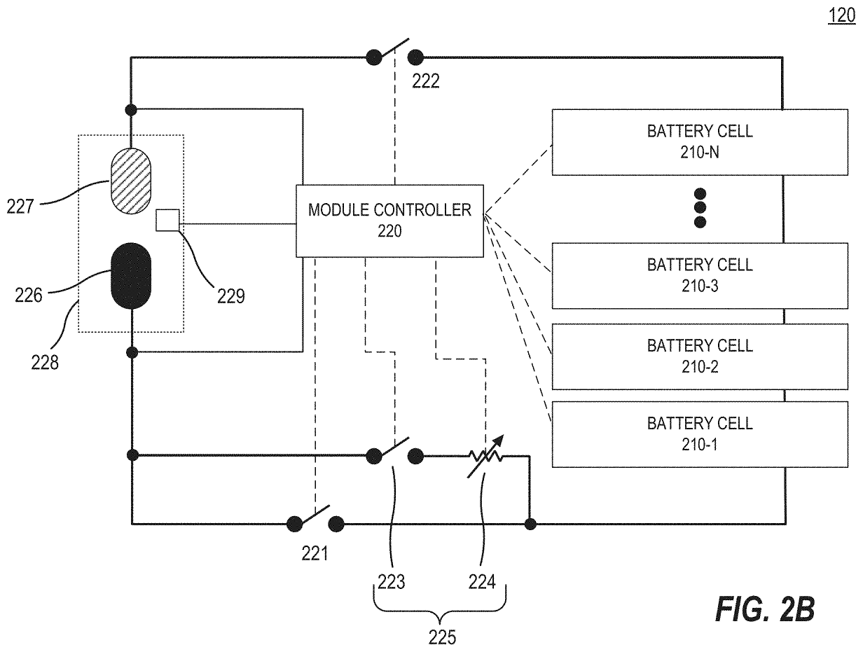

An example of one of the one or more battery modules 120 is shown in FIG. 2A, a perspective view of the exterior of the battery module 120, and FIG. 2B, a block diagram of the battery module 120.

The battery module 120 may include a housing 211 that is configured to mount within the battery rack 110.

Within the housing 211, the battery module 120 may include one or more battery cells 210, which may be lithium-ion battery cells in some embodiments. The battery cells 210 may be in any of a combination of series and parallel configurations, and may provide collectively a total voltage and/or capacity for the battery module 120. Different battery modules 120 in a battery rack 110 may have different capacities and/or voltages.

The battery module 120 may also include within the housing 211 a module controller 220, which in some embodiments may be controlled via a control panel 212 available on an exterior of the housing 211. The module controller 220 may be coupled to temperature, current, and/or voltage sensing circuits (not shown) within the battery module 120 and may be configured to control operations of the battery module. In some embodiments the module controller 220 may be or may include a battery management system (BMS). According to the present disclosure, the module controller 220 may be configured to control the opening and closing of first and second main switches 221 and 222 within the housing 211.

Each of the first and second main switches 221 and 222 may be or may include a contactor, solid state switch, or other mechanisms that may be opened or closed responsive to a signal from the module controller 220. In some embodiments, commands to close or open the switches can also be initiated remotely via a communication port (e.g., communication port 229 discussed in greater detail below), and/or via a wireless interface of the module controller 220.

When the first and second main switches 221 and 222 are closed, each may couple a respective contacts or terminals of the connector 228 at the exterior of the housing 211 to the battery cells 210. More specifically, the first main switch 221, when closed, may connect a first contact terminal 226 (e.g., a negative terminal) with the battery cells 210, and the second main switch 222, when closed, may connect a second contact or terminal 227 (e.g., a positive terminal) to the battery cells 210. The first and second terminals 226 and 227 may be configured to couple to corresponding contacts of the battery rack 110 that provide an electrical path to the bus 113 within the battery rack 110. Thus, when the first and second main switches 221 and 222 are closed, the battery cells 210 may be charged or discharged via an electrical path having the first contact or terminal 226, the first main switch 221, the battery cells 210, the second main switch 222, and the second contact or terminal 227.

The battery module 120 may also include within the housing 211 a pre-charge circuit 223 that includes a pre-charge switch 224 and a variable resistor 225, such as a rheostat. The battery module 120 may control the opening and closing of the pre-charge switch 224 and the variable resistance of the variable resistor 225.

The pre-charge circuit 223 may be configured to prevent an in rush of current, such as that which would exceed a specified amount of current that may be input into the battery module 120 or the cells 210 thereof. Stated differently, the pre-charge circuit 223, in coordination with the module controller 220, may be configured to increase gradually incoming current to the battery module 120 from a pre-determined minimum value to a pre-determined maximum value and/or until the battery module voltage is synchronized with the bus voltage of the battery rack 110.

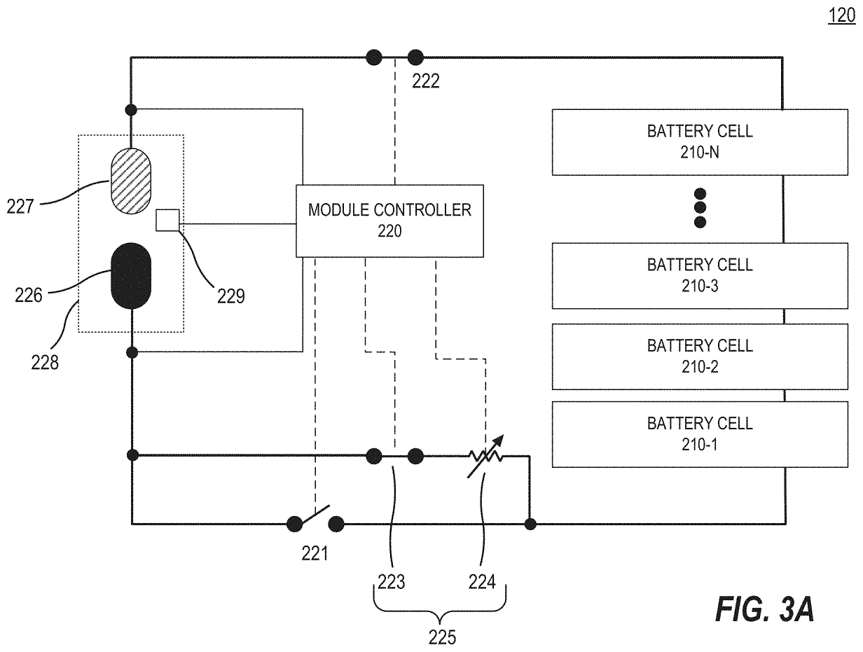

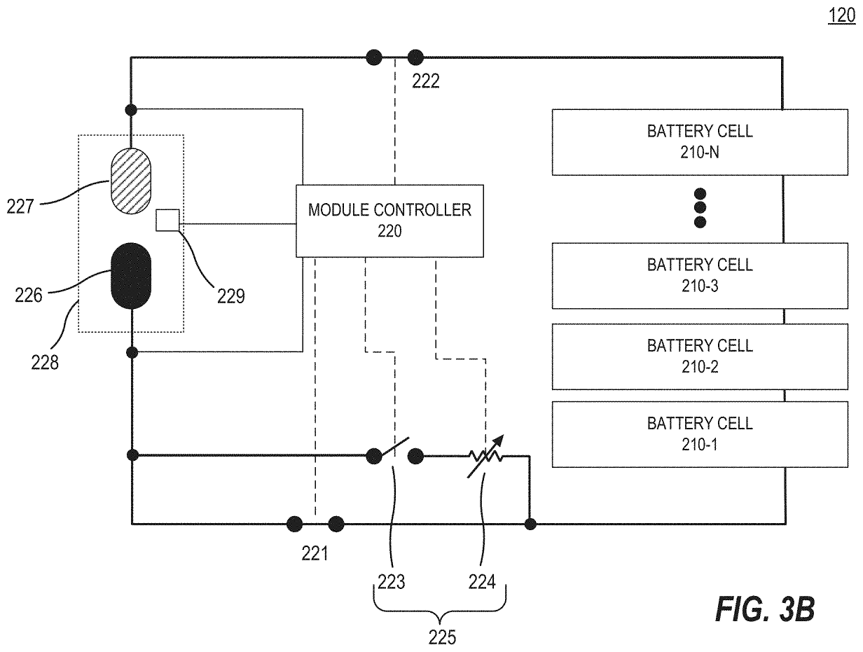

Reference is now made to FIGS. 3A and 3B, which are block diagram of the battery module of FIGS. 2A-B during various states of operation, with FIG. 3A illustrating a state of operation during an initialization and/or pre-charging operation, and FIG. 3B illustrating a state of operation subsequent to the initialization and/or pre-charging operation of FIG. 3A.

Prior to the state of operation illustrated in FIG. 3A, an operator or technician present at the installation site may insert a battery module 120 into the battery rack 110. The module controller 220 may detect the main bus voltage present on the first and second terminals 226 and 227. The module controller 220 may be configured to cause the variable resistance of the variable resistor 225 to be set to a maximum resistance value, if not previously performed.

Then, the operator or technician may indicate that an initialization and/or pre-charging operation of the battery module 120 is to be performed. This may occur responsive to a user input at the rack controller 130 (which may be received from a remote source). As seen in FIG. 3A, the module controller 220 may then signal the second main switch 222 and the pre-charge switch 224 to close, thereby exposing the battery cells 210 and the pre-charge circuit 223 to the bus voltage of the battery rack 110. Due to the presence of the variable resistor 225 set to the maximum resistance value, the amount of current passed to the battery cells 210 may be initially limited.

The module controller 220 may then gradually decrease or change the resistance of the variable resistor 225 thereby resulting in a gradual increase of the current through the battery cells 210. The module controller 220 may periodically measure the voltage across the battery cells 210 and/or the current through the battery cells 210 and perform periodic comparisons between the bus voltage of the battery rack 110 and the voltage across the battery cells 210.

As a result of the periodic comparisons, the module controller 220 may determine or decide that the bus voltage of the battery rack 110 is equal to the voltage across the battery cells 210, and/or that the difference between the voltage across the battery cells 210 and the bus voltage is such that a damaging inrush of current would not occur if the battery cells 210 were exposed to the bus voltage. The initialization and/or pre-charging operation may thus be completed. As seen in FIG. 3B, the module controller 220 may then signal the first main switch 221 to close. In some embodiments, optionally the module controller 220 may signal the pre-charge switch 224 to open after the first main switch 221 is closed.

Accordingly, subsequent to the states of operation illustrated in FIGS. 3A and 3B, the battery module 120 may be coupled to the bus 113 of the battery rack 110, and the battery module 120 may have a voltage that is synchronized to the voltage of the bus 113.

The presence and configuration of the pre-charge circuit 223 and the module controller 220 may enable a “hot swappable” insertion feature that may limit (e.g., may initially limit) the current flowing into a battery module 120 inserted into a battery rack 110. This may allow for an initial mismatch to exist between the bus voltage of the battery rack 110 and the voltage across the battery cells 210.

Returning to FIG. 2B, the module controller 220 may communicate with the rack controller 130 via a communication path, which may be a wired path coupled to a communication port 229 as shown in FIG. 2B, or may be a wireless path.

Referring to FIGS. 2A-B and 3A-B, it may be seen that there are two paths from the first terminal 226 to the battery cells 210: a main path that includes the first main switch 221 and a pre-charge path that includes the pre-charge circuit 223. In some embodiments, the main path and the first main switch 221 thereof may be optional, provided that the presence of the variable resistor 225 along the path from the first terminal 226 to the battery cells 210 is acceptable.

In some embodiments, the second main switch 222 may be optional.

FIGS. 2A-B and 3A-B show the first terminal 226, second terminal 227, and the communication port 229 as components of the single common connector 228, but in some embodiments the first terminal 226, the second terminal 227, and the communication port 229 may be integrated into two or three separate connectors. In some embodiments where a wireless data path between the battery module 120 and the rack controller 130 is used, the communication port 229 may be omitted.

In some embodiments, the battery module 120 and the module controller 220 thereof may be configured a “hot swappable” removal feature that may prevent or reduce a rate of occurrence of an electrical arc. For example, when removing a battery module 120 that is connected to an active bus 113 via closed first and second main switches 221 and 222, and/or a closed pre-charge switch 224, there may be a risk of arcing due to a breaking of the electrical current flow between the battery module 120 and the bus 113. According to the present disclosure, the connectors for the battery can provide advanced warning to the module controller 220 a disconnect action has been requested, which may enable the module controller 220 to transmit a signal to the first and second main switches 221 and 222, and/or the pre-charge switch 224 to open (if closed), and thereby enter into an anti-arcing or disconnected state.

Therefore, in some embodiments, the module controller 220 may be configured to open the first main switch 221, the second main switch 222, and/or the pre-charge switch 224 based on a disconnect signal received from the rack controller 130 (e.g., via a data path such as the wired path coupled to the communication port 229). The rack controller 130 may be configured to transmit the disconnect signal responsive to a command to disconnect the battery module 120 from the battery rack 110. As a first example, a technician (or other individual) may input a command to the rack controller 130 indicating that the battery module 120 is to be removed from the battery rack 110. In response, the module controller 220 may transmit the signal to the first and second main switches 221 and 222, and/or the pre-charge switch 224 to open (if closed), and thereby enter into an anti-arcing or disconnected state.

As a second example, a technician (or other individual) may unlock or open a locking mechanism (not shown in the figures but present on either or both of the battery module 120 and the battery rack 110) that is configured to secure the battery module 120 within the battery rack 110. The unlocking or opening of the locking mechanism may indicate an imminent removal of the battery module 120 from the battery rack 110. In response to a sensing of the unlocking or opening of the locking mechanism, the module controller 220 may transmit the signal to the first and second main switches 221 and 222, and/or the pre-charge switch 224 to open (if closed), and thereby enter into an anti-arcing or disconnected state.

In some embodiments, a component within the battery module 120 may be configured to generate and transmit the disconnect signal without the involvement of the rack controller 130. For example, when the locking mechanism configured to secure the battery module 120 within the battery rack 110 is present on a housing 211 of the battery module 120, the sensing of the unlocking or opening of the locking mechanism may be performed by the module controller 220. As another example, the technician (or other individual) may input a command via the control panel 212 of the battery module 120 indicating that the battery module 120 is to be removed from the battery rack 110.

In response to a disconnect action or disconnect signal, examples of which are provided above, the module controller 220 may be able to enter into an anti-arcing or disconnected state, preventing or reducing a rate of occurrence of electrical arcs that may arise from disconnecting the battery module 120 from an active bus of the battery rack 110, especially when such removals are unexpected (e.g., a technician inadvertently unlocks and attempts to remove a second battery module 120-2 instead of an intended first battery module 120-1).

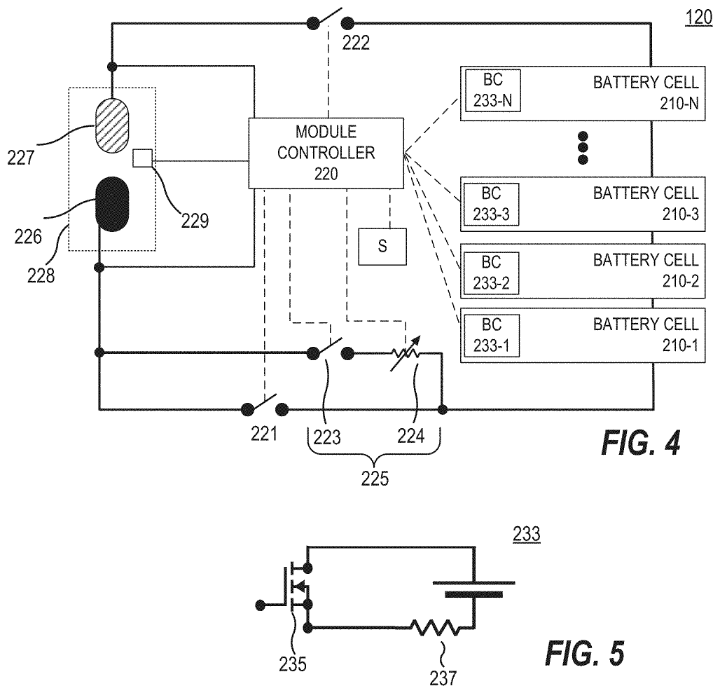

As discussed above, not all removals of the battery module 120 from the battery rack 110 may be authorized removals. According to some embodiments of the present disclosure, and referring to FIGS. 4 and 5, the battery module 120 may be equipped with an anti-theft disabling feature.

The battery module 120 may be configured to detect an unauthorized removal, for example, by the sensing of the unlocking or opening of the locking mechanism in an unexpected manner (e.g., without entry of a command by an authorized technician or other individual indicating that the battery module 120 is to be removed). In response, as discussed above, the module controller 220 may enter the battery module 120 into the disconnected state by transmitting the signal to the first and second main switches 221 and 222, and/or the pre-charge switch 224 to open (if closed).

In some embodiments, the battery module 120 may include a position or location sensor S (e.g., a Global Positioning System (GPS) sensor) that provides position or location information to the module controller 220. The module controller 220 may store in memory thereof expected geographic position or location information that indicates an expected location of the battery module 120 (for example, a latitude and longitude). In some embodiments, the module controller 220 may also store radius information indicating a radius corresponding to a circle centered on the expected location of the battery module 120 that may be considered as equivalent to the expected location of the battery module 120. In some embodiments, data associated with a geometric fence may be stored. The geometric fence, which may be non-circular, may be defined by a sequence of GPS locations, and may bound an area equivalent to the expected geographic position or location of the battery module 120. If the position or location sensor S provides to the module controller 220 position or location information that is not the expected location of the battery module 120 or is not equivalent to the expected location of the battery module 120 (e.g., the position or location information is outside the circle centered on the expected location of the battery module 120 or outside the geometric fence), then the module controller 220 may determine that the battery module 120 has been removed in an unauthorized fashion. As such, some false positives that may stem from an unexpected but authorized removal may be avoided.

Based on the detecting of the unauthorized removal, the module controller 220 may instantiate a timer that corresponds to a predetermined and/or configurable time window.

During the time window, the module controller 220 may be configured to receive user input from an authorized user or technician indicating an authorization code. In some embodiments, the authorization code may be a pre-determined sequence of button pushes and/or other user inputs, or a data transmission transmitted from an external device to the module controller 220 via a data path. For example, the authorized user or technician may re-insert the battery module 120 into the battery rack 110 and enter input into the rack controller 130.

Entry of the authorization code may indicate to the module controller 220 that the removal of the battery module 120 into the battery rack 110 was authorized, or that the battery module 120 has been recovered in a timely manner.

After the time window has elapsed (e.g., after the timer instantiated by the module controller 220 exceeds a threshold value), if the authentication code has not been entered or received, the module controller 220 may initiate a self-disabling function to remove charge from the battery cells 210. For example, the module controller 220 may activate a balancing circuit 233 within each battery cell 210. An example of a balancing circuit 233 having a transistor 235 and a resistor 237 is shown in FIG. 5. When the transistor 235 is enabled, the charge from the battery cell may be depleted as resistive losses via the resistor 237. In some embodiments, the balancing circuit 233 may be activated for a period of time such that the charge in the battery cell 210 is depleted below a minimum level (e.g., below a minimum open-circuit voltage), such that internal safety circuitry of the battery module 120 or battery cells 210 will not permit recharging of the battery cells 210, resulting in the battery module 120 and battery cells 210 being unavailable for use.

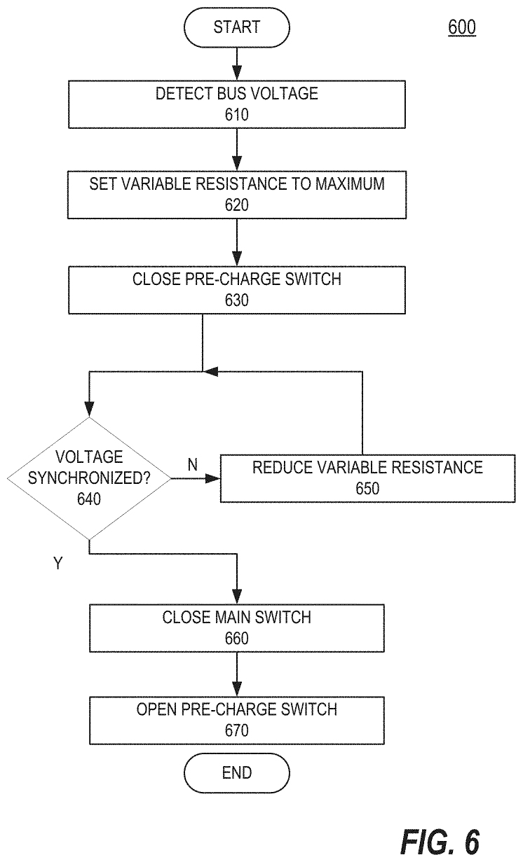

In addition to the above-described systems and apparatuses, the present disclosure provides methods that facilitate the installing, maintaining, upgrading, and/or removing of battery modules without service interruption, as well as methods that facilitate the disabling of a battery module if removed from an electrical power system in an unauthorized manner. Examples of flowcharts illustrating aspects of various methods of controlling and/or operating the system of FIG. 1 and/or the battery module of FIGS. 2A-5 are described with reference to FIGS. 6-8.

FIG. 6 is a flowchart of a method 600 of performing an initialization and/or pre-charging operation on a battery module 120 inserted into or coupled with a battery rack 110.

Prior to the method of FIG. 6, an operator or technician present at the installation site may insert a battery module 120 into the battery rack 110. The module controller 220 may detect the main bus voltage present on the first and second terminals 226 and 227 (block 610). The module controller 220 may be configured to set the variable resistance of the variable resistor 225 to a maximum resistance value, if not previously performed (block 620).

The module controller 220 may then signal the pre-charge switch 224 to close, thereby exposing the battery cells 210 and the pre-charge circuit 223 to the bus voltage of the battery rack 110 (block 630). In embodiments where the second main switch 222 is present, the second main switch 222 may also be closed. In some embodiments, the closing of the pre-charge switch 224 (and second main switch 222) may be performed responsive to a user input at the rack controller 130 or battery module 120 (which may be received from a remote source).

The module controller then may receive measurements of the voltage across the battery cells 210 and/or the current through the battery cells 210 and perform periodic comparisons between the bus voltage of the battery rack 110 and the voltage across the battery cells 210 to determine or decide that the voltage across the battery cells 210 is synchronized with the bus voltage of the battery rack 110 (block 640). If the voltage is not synchronized (e.g., the difference between the voltage across the battery cells 210 and the bus voltage is such that a damaging inrush of current may occur if the battery cells 210 were exposed to the bus voltage) (“N” branch from block 640) then the module controller 220 may gradually decrease or change the resistance of the variable resistor 225 thereby resulting in a gradual increase of the current through the battery cells 210 (block 650).

If the voltage is synchronized (e.g., the difference between the voltage across the battery cells 210 and the bus voltage is such that a damaging inrush of current would not occur if the battery cells 210 were exposed to the bus voltage) (“Y” branch from block 640) then the module controller 220 may then signal the first main switch 221 to close (block 660). In some embodiments, optionally the module controller 220 may signal the pre-charge switch 224 to open after the first main switch 221 is closed (block 670).

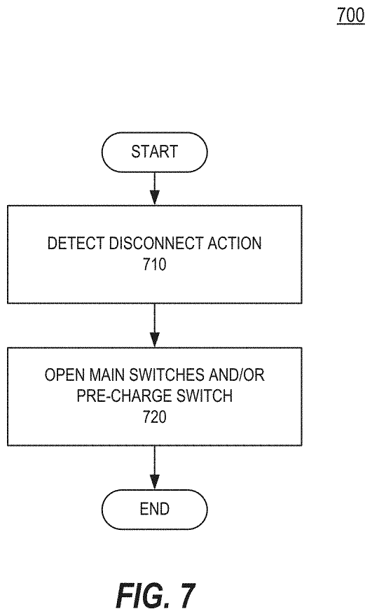

FIG. 7 is a flowchart of a method 700 of performing an arc prevention operation associated with removal of a battery module 120 from a battery rack 110.

The battery module 120 may be configured to detect that a disconnect action has been performed (block 710). For example, the battery module 120 may receive a disconnect signal in response to a command to disconnect the battery module 120 from the battery rack 110. One example of a disconnect action may be a technician inputting a command to the rack controller 130 indicating that the battery module 120 is to be removed from the battery rack 110. Another example of a disconnect action may be a technician (or other individual) unlocking or opening a locking mechanism that is configured to secure the battery module 120 within the battery rack 110. The battery module 120 may be configured to detect these (and other) disconnect actions.

In response to detecting that a disconnect action has been performed, the module controller 220 may transmit a signal to open (if closed) the first and second main switches 221 and 222 and/or the pre-charge switch 224 (block 720), and thereby enter into an anti-arcing or disconnected state.

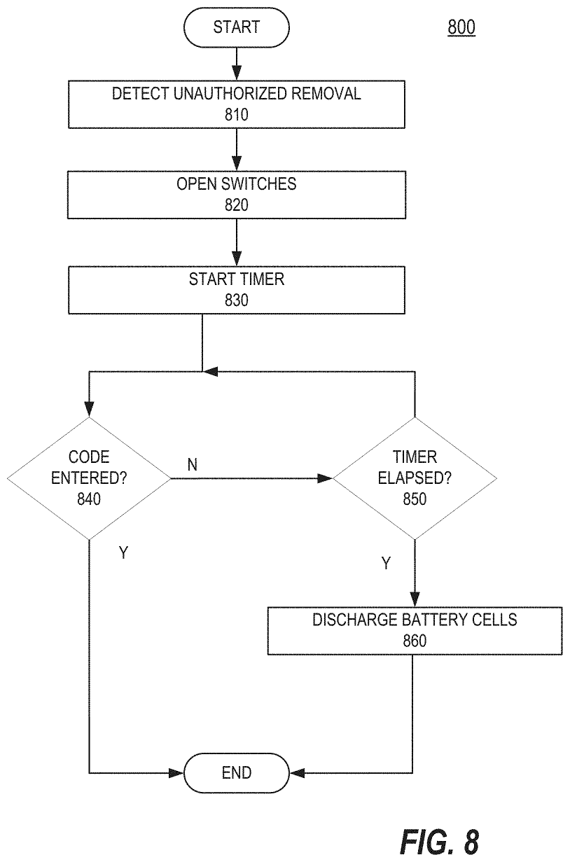

FIG. 8 is a flowchart of a method 800 of detecting an unauthorized removal of a battery module 120 from a battery rack 110 and disabling the battery module 120 after a time window.

The battery module 120 may detect a potentially unauthorized removal (block 810). As a first example, the battery module 120 may sense the unlocking or opening of a locking mechanism in an unexpected manner (e.g., without entry of a command by an authorized technician or other individual indicating that the battery module 120 is to be removed). In response, as discussed above, the module controller 220 may enter the battery module 120 into the disconnected state by transmitting the signal to the first and second main switches 221 and 222, and/or the pre-charge switch 224 to open (if closed) (block 820).

Based on the detecting of the potentially unauthorized removal, the module controller 220 may instantiate a timer that corresponds to a predetermined and/or configurable time window (block 830).

During the time window, the module controller 220 may be configured to receive user input from an authorized user or technician indicating an authorization code (block 840). Entry of the authorization code may indicate to the module controller 220 that the removal of the battery module 120 from the battery rack 110 was in fact authorized, or that the battery module 120 has been recovered from an unauthorized removal in a timely manner (“Y” branch from block 840).

If the authentication code has not been correctly entered or received (“N” branch from block 840), the module controller 220 may determine whether the time window has elapsed (e.g., after the timer instantiated by the module controller 220 exceeds a threshold value) (block 850). If the timer has not elapsed (“N” branch from block 850), the module controller may wait for input. Once the timer has elapsed (“Y” branch from block 850), and the authentication code has not been entered or received, the module controller 220 may initiate a self-disabling function to remove charge from the battery cells 210 (block 860). In some embodiments, as discussed above, balancing circuits of the battery module 120 may be activated for a period of time such that the charge in the battery cells 210 thereof is depleted below a minimum level, resulting in the battery module 120 and battery cells 210 being unavailable for use.

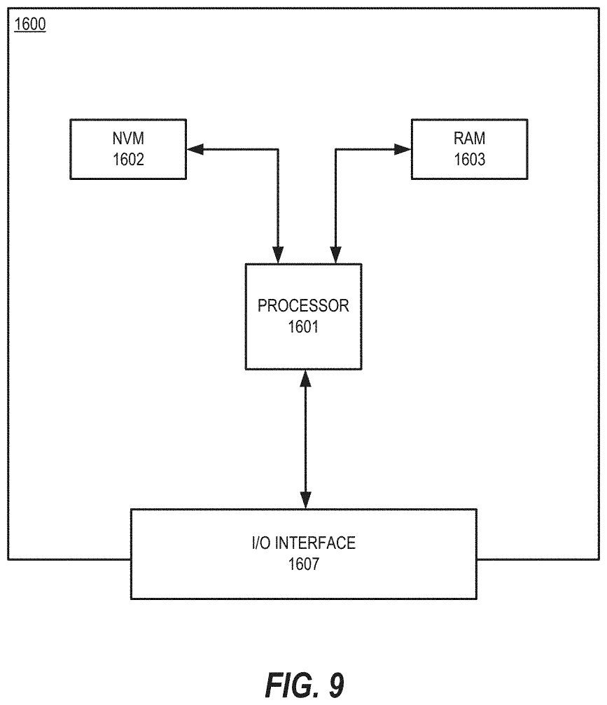

FIG. 9 illustrates various components of a microcontroller 1600 which may be a computing device used in the implementation of one or more of the devices herein, such as the module controller 220 or the rack controller 130. FIG. 9 illustrates hardware elements that can be used in implementing any of the various computing devices discussed herein. In some aspects, general hardware elements may be used to implement the various devices discussed herein, and those general hardware elements may be specially programmed with instructions that execute the algorithms discussed herein. In special aspects, hardware of a special and non-general design may be employed (e.g., ASIC or the like). Various algorithms and components provided herein may be implemented in hardware, software, firmware, or a combination of the same.

A microcontroller 1600 may include one or more processors 1601, which may execute instructions of a computer program to perform any of the features described herein. The instructions may be stored in any type of computer-readable medium or memory, to configure the operation of the processor 1601. For example, instructions may be stored in a non-volatile memory 1602, which may be a read-only memory and/or in a volatile memory, such as random-access memory (RAM) 1603. In some embodiments, a removable media, such as a hard disk, Universal Serial Bus (USB) drive, compact disk (CD) or digital versatile disk (DVD), floppy disk drive, or any other desired electronic storage medium may be used. The microcontroller 1600 may be configured to provide output to one or more output devices (not shown) such as printers, monitors, display devices, and so on, and receive inputs, including user inputs, via input devices (not shown), such as a remote control, keyboard, mouse, touch screen, microphone, or the like. The microcontroller 1600 may also include input/output interfaces 1607 which may include circuits and/or devices configured to enable the microcontroller 1600 to communicate with external input and/or output devices (such as computing devices on a network) on a unidirectional or bidirectional basis. The components illustrated in FIG. 9 (e.g., processor 1601, non-volatile memory 1602) may be implemented using basic computing devices and components, and the same or similar basic components may be used to implement any of the other computing devices and components described herein. For example, the various components herein may be implemented using computing devices having components such as a processor executing computer-executable instructions stored on a computer-readable medium, as illustrated in FIG. 9.

Aspects of the present disclosure have been described above with reference to the accompanying drawings, in which embodiments of the inventive concepts are shown. It will be appreciated, however, that the inventive concepts may, however, be embodied in many different forms and should not be construed as limited to the embodiments set forth above. Rather, these embodiments are provided so that this disclosure will be thorough and complete, and will fully convey the scope of the inventive concepts to those skilled in the art. Like numbers refer to like elements throughout.

It will be understood that, although the terms first, second, etc. are used throughout this specification to describe various elements, these elements should not be limited by these terms. These terms are only used to distinguish one element from another. For example, a first element could be termed a second element, and, similarly, a second element could be termed a first element, without departing from the scope of the present inventive concepts. The term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In the drawings and specification, there have been disclosed typical embodiments of the inventive concepts and, although specific terms are employed, they are used in a generic and descriptive sense only and not for purposes of limitation, the scope of the inventive concepts being set forth in the following claims.

1. An electrical power system configured to provide backup electrical power to a load, the electrical power system comprising:
a battery rack having a bus configured to provide power; and
a battery module configured to couple with the bus and receive power therefrom, the battery module comprising battery cells coupled to a pre-charge electrical path and a main electrical path, and a module controller configured to:
detect that the battery module has been inserted into the battery rack; and
pre-charge the battery cells of the battery module via the pre-charge electrical path until a voltage level of the battery cells is synchronized with a voltage level of the bus.

2. The electrical power system of claim 1, wherein the pre-charge electrical path comprises a pre-charge switch, and wherein the module controller is configured to pre-charge the battery cells of the battery module until the voltage level of the battery cells is synchronized with the voltage level of the bus by closing the pre-charge switch.

3. The electrical power system of claim 2, wherein the pre-charge electrical path further comprises a variable resistance in series with the pre-charge switch.

4. The electrical power system of claim 3, wherein the module controller is configured to pre-charge the battery cells of the battery module via the pre-charge electrical path until the voltage level of the battery cells is synchronized with the voltage level of the bus by adjusting a resistance of the variable resistance.

5. The electrical power system of claim 4, wherein the module controller is configured to set the resistance of the variable resistance to a maximum value prior to closing the pre-charge switch.

6. The electrical power system of claim 2, wherein the battery module further comprises a main switch on the main electrical path, and wherein the module controller is further configured to:
detect that the voltage level of the battery cells is synchronized with the voltage level of the bus; and
close the main switch on the main electrical path in response to detecting that the voltage level of the battery cells is synchronized with the voltage level of the bus.

7. The electrical power system of claim 6, wherein the module controller is configured to open the pre-charge switch after the main switch is closed.

8. A battery module configured to couple with a bus of a battery rack and receive power therefrom, the battery module comprising battery cells and a module controller configured to:
detect that the battery module has been inserted into the battery rack; and
pre-charge the battery cells of the battery module via a pre-charge electrical path until a voltage level of the battery cells is synchronized with a voltage level of the bus.

9. The battery module of claim 8, wherein the pre-charge electrical path comprises a pre-charge switch, and wherein the module controller is configured to pre-charge the battery cells of the battery module until the voltage level of the battery cells is synchronized with the voltage level of the bus by closing the pre-charge switch.

10. The battery module of claim 9, wherein the pre-charge electrical path further comprises a variable resistance in series with the pre-charge switch.

11. The battery module of claim 10, wherein the module controller is configured to pre-charge the battery cells of the battery module via the pre-charge electrical path until the voltage level of the battery cells is synchronized with the voltage level of the bus by adjusting a resistance of the variable resistance.

12. The battery module of claim 10, wherein the module controller is configured to set a resistance value of the variable resistance to a maximum resistance value prior to closing the pre-charge switch.

13. The battery module of claim 9, further comprising a main switch on a main electrical path different from the pre-charge electrical path, and wherein the module controller is further configured to:
detect that the voltage level of the battery cells is synchronized with the voltage level of the bus; and
close the main switch in response to detecting that the voltage level of the battery cells is synchronized with the voltage level of the bus.

14. The battery module of claim 13, wherein the module controller is configured to open the pre-charge switch after the main switch is closed.

15. A method comprising:
detecting, by a module controller of a battery module, that the battery module has been inserted into a battery rack; and
pre-charging, by the module controller, battery cells of the battery module until a voltage level of the battery cells is synchronized with a voltage level of a bus of the battery rack by closing a pre-charge switch on a pre-charge electrical path that is in parallel with a main switch on a main electrical path.

16. The method of claim 15, wherein the pre-charge electrical path further comprises a variable resistance in series with the pre-charge switch.

17. The method of claim 16, wherein pre-charging the battery cells of the battery module until the voltage level of the battery cells is synchronized with the voltage level of the bus comprises adjusting a resistance of the variable resistance.

18. The method of claim 16, further comprising:
setting, by the module controller, a resistance value of the variable resistance to a maximum resistance value prior to closing the pre-charge switch.

19. The method of claim 15, further comprising:
detecting, by the module controller, that the voltage level of the battery cells is synchronized with the voltage level of the bus; and
closing the main switch in response to detecting that the voltage level of the battery cells is synchronized with the voltage level of the bus.

20. The method of claim 19, further comprising:
opening the pre-charge switch after the main switch is closed.

21-56. (canceled)
